(19) United States
(12) Patent Application Publication
(10) Pub. No.: US 2026/0330020 A1
(43) Pub. Date: Oct. 22, 2026

(54) GENERATIVE AI POWERED CYBERSECURITY RECOMMENDATION ENGINE

(71) Applicant: Dell Products L.P., Round Rock, TX (US)

(72) Inventors: Deepak Gaikwad, Natick, MA (US); Judith A. Furlong, Natick, MA (US); Raj Suryavanshi, Leander, TX (US); Said Tabet, Austin, TX (US)

(21) Appl. No.: 19/180,551

(22) Filed: Apr. 16, 2025

(51) Int. Cl. G06F 21/57; G06Q 10/0631

(52) U.S. Cl. CPC G06F 21/577; G06Q 10/06316

(57) ABSTRACT

Techniques for improving security policy adherence are disclosed. A service accesses source data, which is accessible to an LLM. The source data is associated with sources that are being evaluated to determine their security postures based on their adherence to policies. The service causes the LLM to generate a corresponding trust score for each source. The service causes the LLM to rank the sources based on the trust scores, resulting in generation of a ranked list. The service accesses a digital twin of an environment comprising the sources. The service tasks the digital twin to analyze the ranked list. The digital twin generates a re-ranked list of sources. The service generates a workflow structured to implement a set of configuration solutions for the set of sources. An order of the workflow is based on the re-ranked list.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to improving security postures of sources. More particularly, at least some embodiments relate to systems, hardware, software, computer-readable media, and methods for generating optimized rankings of operational recommendations/solutions for sources based on trust scores, size, scope, and criticality.

### BACKGROUND

The term “cybersecurity” generally refers to the practice of protecting computers, networks, programs, and data from unauthorized access, attacks, or damage. Cybersecurity often involves a wide range of measures and strategies designed to prevent cyber threats. Examples of such threats include, but certainly are not limited to, hacking, malware, and phishing attacks. Cybersecurity aims to ensure the confidentiality, integrity, and availability of data and systems, thereby safeguarding both personal and organizational information.

Cybersecurity generally involves a number of activities. One such activity relates to network security. Network security involves protecting the infrastructure of a computer network from attacks and ensuring secure communication channels. Another activity relates to information security, which involves safeguarding sensitive data from unauthorized access, disclosure, or modification. Another activity relates to application security, which involves ensuring that software and applications are designed and maintained to be secure from vulnerabilities. Another activity relates to endpoint security, which involves protecting devices like computers, smartphones, and tablets that connect to the network from threats.

Another activity relates to identity and access management, which involves managing who has access to systems and data, thereby ensuring that only authorized users can gain access. Another activity relates to incident response, which involves developing strategies for responding to and recovering from security breaches or cyberattacks. Another activity relates to disaster recovery and business continuity, which involves ensuring that systems and data can be restored after an attack or failure, minimizing downtime.

Cybersecurity is essential in today's digital world, where more services, businesses, and personal data are being handled online. It helps prevent identity theft, data breaches, financial loss, and other potentially devastating consequences of cyberattacks.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example of a retrieval-augmented generation (RAG) system.

FIG. 2 illustrates a computing architecture for generating optimized rankings of operational recommendations/solutions for sources based on trust scores, size, scope, and criticality.

FIG. 3 illustrates a pre-processing phase for data.

FIG. 4 illustrates an example workflow for ranking sources based on trust scores.

FIG. 5 illustrates an optimized ranking technique.

FIG. 6 illustrates a flowchart of an example method for generating optimized rankings of operational recommendations/solutions for sources based on trust scores, size, scope, and criticality.

FIG. 7 illustrates an example computer system that can be configured to perform any of the disclosed operations.

### DETAILED DESCRIPTION

Security teams are inundated with cloud security alerts. For instance, it is often the case that security teams have to deal with more than 500 security alerts each day. Interestingly, a large number of these alerts are inaccurate or unnecessary. In fact, more than 40% of the alerts are false positives and another 40% of alerts end up being classified as low priority.

Reviewing and prioritizing alerts is a major task. Indeed, many security administrators spend more than 20% of their day reviewing alerts and deciding which ones should be dealt with first. Reviewing these alerts results in numerous challenges. For example, the administrators may experience “alert fatigue” from reviewing such a large number of alerts each day. Alert fatigue can cause turnover and can result in missing truly critical alerts. Alert fatigue causes burnout, turnover, and internal friction. As a result of alert fatigue, critical alerts may be missed, often on a daily and weekly basis.

The process of learning and analyzing new threats and their impact to the ever-growing cyber-infrastructure is also not an easy task. New threats from internal and external sources are subjected to evaluation by isolating those threats and then resolving them in accordance with a “zero-day” requirement.

In cybersecurity, “zero-day” refers to a vulnerability or flaw in software or hardware that is unknown to the vendor or the public. The term “zero-day” comes from the fact that the developers have had zero days to fix or address the vulnerability, as it has not been discovered yet.

A zero-day requirement typically refers to the need to address or defend against vulnerabilities that are exploited before the vendor or security experts can create a patch or update to fix them. These types of threats are particularly dangerous because there is no immediate defense, and the exploited vulnerability can be used by attackers to gain unauthorized access, cause damage, or steal sensitive data without detection.

Zero-day vulnerabilities are highly valuable on the black market, and cybercriminals often seek them out to exploit systems before they are discovered or patched. They can also be used in targeted attacks, such as in advanced persistent threats (APTs), where the attacker maintains a stealthy and long-term presence in a network.

There are various attributes or aspects of zero-day security. One aspect relates to discovery, where zero-day vulnerabilities are discovered either by the attackers themselves or by independent security researchers. Another aspect relates to exploitation, where hackers can use zero-day exploits to launch cyberattacks, install malware, or breach systems before the flaw is publicly known. Another aspect relates to patch development, where, once the vulnerability is discovered, the software vendor works to develop and release a patch or fix. By then, however, the damage may have already been done if attackers have already exploited it.

There are various strategies for implementing a zero-day defense. One strategy relates to threat intelligence, which involves using advanced threat detection and sharing information about newly discovered vulnerabilities can help mitigate zero-day risks. Another strategy relates to behavioral analysis, which involves monitoring network traffic and system behavior to identify unusual or suspicious activity that could indicate an exploit is in progress. Another strategy relates to layered security, which involves employing multiple layers of defense (e.g., firewalls, intrusion detection systems, antivirus) to protect against attacks that take advantage of unknown vulnerabilities. Another strategy relates to timely patching, where, once a vulnerability is discovered and a patch is released, it is desirable to quickly apply updates and patches. In short, a zero-day requirement refers to the need for proactive strategies and tools to defend against unknown or newly discovered vulnerabilities until a fix can be implemented.

Security incident identification can sometimes take days to months. This prolonged timespan can negatively impact “effective” security, thereby leading to unacceptable risk exposure. Lost opportunities in fixing threats also increases the cost of cybersecurity and impacts security posture as well as cyber-insurance. As used herein, “security posture” generally refers to the overall security status of an organization's information technology (IT) environment with respect to a given set of one or more policies.

It should also be noted how scheduling fixes often does not include comprehensive risk analysis of the overall cyber-estate. The omission of a comprehensive risk analysis can impact work scheduling in a negative manner. For instance, lower risk bugs might be fixed first (instead of last) because they are relatively easier to fix.

At least some of the disclosed embodiments are beneficially designed to address the above problems. In particular, at least some of the embodiments are directed to a recommendation engine that supports “self-driving” threat lifecycles from the identification phase to the operationalization phase. Advantageously, some of the embodiments leverage artificial intelligence (AI) for information technology (IT) operations, where the embodiments use machine learning (ML) and analytics to automate data collection from internal and external sources. Some of the embodiments can then transform the collected data into usable or more usable forms and can evaluate massive amounts of data across multiple sources to identify patterns of activity across an organization. Examples of such patterns of activity can include when and where people sign in, traffic volumes, and the devices and cloud apps that employees use. Doing so can help some of the embodiments identify potential threats in real time.

Some of the embodiments also continuously analyze current threats from internal and external sources and streams, in real time. Some of the embodiments can then store the latest threats in a vector database along with corresponding severity ratings.

Some of the embodiments are further configured to analyze the threats against the data collected and then rank the identified threats based on various techniques. This ranking can occur in near real time. By ranking the threats, the sources of those threats can also be ranked. Also, some of the embodiments beneficially rank the threats in order of severity based on certain predefined threat ratings while avoiding duplication. Doing these operations beneficially enables some of the embodiments to identify potential remedies (e.g., matching knowledge articles), identifying impacted resources, and updating trust scores in real time.

Another advantage is that some of the embodiments simulate risk analysis of the incident impact and possible solutions on a “digital twin” of the enterprise's operational model; they update recommended/alternative solutions (e.g., impact of isolating apps, network isolation, app server isolation, cluster); and they improve accuracy and time estimates of the recommended solution.

A “digital twin” is a virtual model or simulation of a physical object, system, or process. A digital twin uses real-time data from sensors and other sources to mirror the behavior, performance, and condition of its physical counterpart. Essentially, a digital twin is a digital replica that allows for analysis, monitoring, and optimization without having to interact directly with the physical object itself.

Another advantage is that some of the embodiments can reorder the “operational recommendation” that matches priorities based on risk to critical infrastructure and can present candidates in order that match threats, scope, size, and risks for the most optimal job-schedule for IT operation. Some of the embodiments can also beneficially implement threat detection, risk analysis, and job scheduling in a single step or optionally in multiple steps in near real-time. Doing so allows security teams to focus on critical incidents, thereby reducing alert fatigue.

Some of the embodiments are also beneficially configured to enable continuous learning. For instance, these embodiments can update the trust score upon work completion, can update knowledge articles by analyzing time, scope, and skills required for job completion, and can automate security posture assessment dynamically. It should be noted how the disclosed operations can also be realized using a combination of generative artificial intelligence (GenAI) and machine learning (ML) as well as and neural symbolic AI.

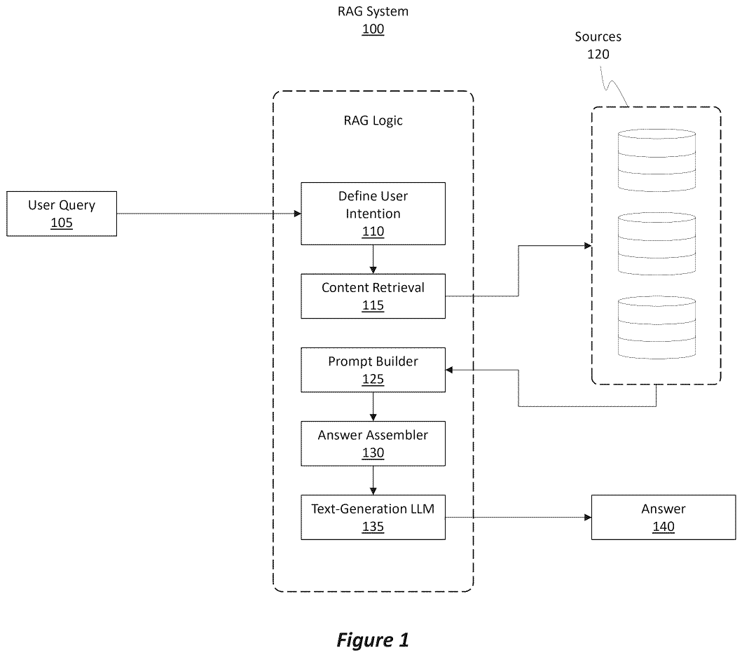

Having just provided some context information and some details regarding some of the benefits and advantages provided by the disclosed embodiments, attention will now be directed to FIG. 1, which illustrates an example retrieval augmented generation (RAG) system, which can be implemented by at least some of the disclosed embodiments.

This new structure (i.e. RAG) relates to a new set of techniques and algorithms that manage databases, large language model (LLM) contexts, and user intention. In a RAG system, the quality of the response is predicated on the large language model's (LLM's) capabilities and the quality of the retrieval algorithm. The retrieval algorithm relies on a pre-processing step to move internal data (e.g., such as from presentations, reports, etc.) into a context that is readable by an LLM. During this process, it is common to disperse documents into different databases that can be probed independently during the retrieval process.

RAG is a process that leverages LLMs to generate content given a user query. Relevant attributes for a high quality RAG relate to a high quality retrieval algorithm and a high quality LLM that can take advantage of the algorithm. The retrieval algorithm gathers content from a database and inserts that content into an LLM context (e.g., into an LLM prompt). The LLM can then use the content from the database to answer the query.

To illustrate, FIG. 1 displays a generic RAG system 100 and its main phases or modules, ranging from receiving a user query 105 to generating an answer. In FIG. 1, the “Define User Intention” module 110 uses the user query 105 to model the rest of the pipeline. Often, these steps involve moderation or the customization of an instruction prompt.

The “Content Retrieval” module 115 then involves querying one, some, or all available sources 120 (e.g., databases) that have pre-processed textual content in a chunk-like manner. These sources 120 are normally vector databases that support a similarity search operation.

The textual content is returned at the “Prompt Builder” module 125. This module identifies the results that are determined to be most relevant with respect to the user's query. Those results will be used to generate a prompt for the LLM. Because of a limited context size dictated by the “Text-generation LLM” module, the disclosed embodiments allow only the highest ranked sources to be inserted into the prompt.

An answer assembler module 130 will use the prompt as input. This module requests an answer from the text-generation LLM 135, which will produce the desired response or answer 140. Additional steps, such as re-ranking or post-processing on the output of the text-generation LLM, can also be included in some renditions of the RAG system 100.

Exploiting vector embeddings (e.g., the RAG system 100 of FIG. 1) is particularly relevant for customer applications running at a network's edge. Normally, vector embeddings are stored and managed via a vector database (DB). Notably, some of the customer applications generating and querying embeddings can induce huge workloads for which an unproperly provisioned vector DB may struggle to cope with. Applications that generate vector embeddings from video frames are both commercially interesting and workload intensive.

Vector DBs are specialized systems designed to manage and query high-dimensional vector data efficiently. These databases are beneficial for artificial intelligence (AI) and machine learning (ML) applications, where data is often represented as vectors or embeddings. Vector DBs enable fast and scalable similarity searches, which are beneficial for tasks such as image retrieval, recommendation systems, and natural language processing.

By storing data in vector form, these databases can leverage advanced indexing techniques to perform quick nearest neighbor searches. Embeddings play a beneficial role in vector databases, serving as the numerical representation of data objects in a continuous vector space. These embeddings are generated using machine learning models that transform complex data types, such as images or text, into fixed-length vectors that capture the intrinsic features of the original data. For instance, image embeddings translate visual content into vectors that reflect visual similarity. This transformation allows for efficient comparison and retrieval of similar items based on their vector representations.

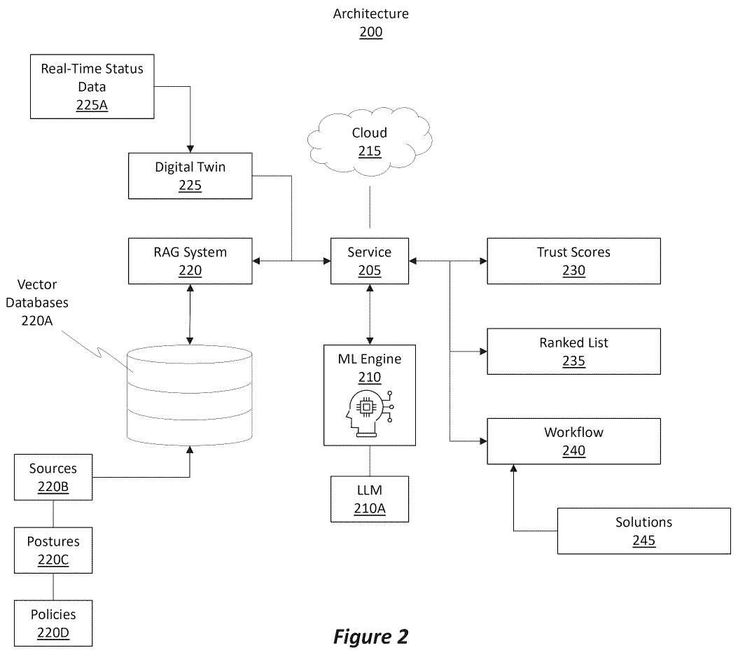

With that understanding, attention will now be directed to FIG. 2, which illustrates an example computing architecture 200 in which the disclosed principles may be employed. Architecture 200 shows a service 205.

As used herein, the term “service” refers to an automated program that is tasked with performing different actions based on input. In some cases, service 205 can be a deterministic classifier that operates fully given a set of inputs and without a randomization factor. In other cases, service 205 can be or can include a machine learning (ML) or artificial intelligence engine, such as ML engine 210. The ML engine 210 enables service 205 to operate even when faced with a randomization factor. The ML engine 210 can include or can be associated with a large language model (LLM) 210A. The LLM 210A can be tasked with assisting the service 205 in any of the disclosed operations.

As used herein, reference to any type of machine learning or artificial intelligence (or large language model (LLM)) may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 205 is a local service operating on a local device, such as an edge device. In some implementations, service 205 is a cloud service operating in a cloud 215 environment. In some implementations, service 205 is a hybrid service that includes a cloud component operating in cloud 215 and a local component operating on a local device. These two components can communicate with one another.

Service 205 is generally tasked with facilitating the update or reconfiguration of a set of sources to enable those sources to better adhere to one or more security policies. In particular, FIG. 2 shows how service 205 is able to access a RAG system 220, which is associated with vector databases 220A. The RAG system 220 is representative of the RAG system 100 of FIG. 1, and the vector databases 220A are representative of the sources 120.

Service 205 can curate or facilitate the curation of source data and can include the source data in the vector databases 220A. Notably, the vector databases 220A are accessible to a threat large language model (LLM), such as the LLM 210A. The source data is associated with a set of sources 220B that are being evaluated to determine security postures 220C for the set of sources 220B based on the set of sources 220B adherence to a set of one or more security policies 220D.

Service 205 causes the threat LLM (e.g., LLM 210A) to generate a corresponding trust score for each respective source in the set of sources 220B, as shown by trust scores 230. The trust scores 230 reflect the security postures 220C for the set of sources 220B and can be based on the type of security alerts the sources are providing or the types of attacks the sources are subjected to.

Service 205 causes the LLM 210A to rank the set of sources 220B based on the trust scores 230. This ranking operation results in the generation of a ranked list 235 of sources. That is, the sources 220B are ranked based on their trust scores 230. Sources that have relatively poor trust scores are ones that should be prioritized for reconfiguration or for attention so as to improve their security postures. Sources that have relatively better trust scores can be deprioritized in view of the sources that have the relatively worse scores.

Service 205 accesses a digital twin 225. This digital twin 225 digitally represents a computing environment comprising one, some, or all of the sources 220B.

Service 205 tasks the digital twin 225 to analyze the ranked list 235 of sources provided by the LLM 210A. The digital twin 225 is further tasked with re-ranking the ranked list of sources based on real-time status data 225A for the computing environment. The digital twin 225 generates a re-ranked list of sources. Whereas the LLM 210A may be operating on somewhat outdated data with respect to the environment, the digital twin 225 is operating using the real-time status data 225A for the environment. As such, the digital twin 225 can likely provide a better ranking as compared to the LLM 210A.

Service 205 then facilitates the generation of a workflow 240 structured to implement a set of configuration solutions 245 for the set of sources 220B. The set of configuration solutions 245 are structured to cause the set of sources 220B to at least attempt to adhere to the security policies 220D. Also, an order of the workflow 240 is based on the re-ranked list of sources. Further details on these operations will now be described with respect to the remaining Figures.

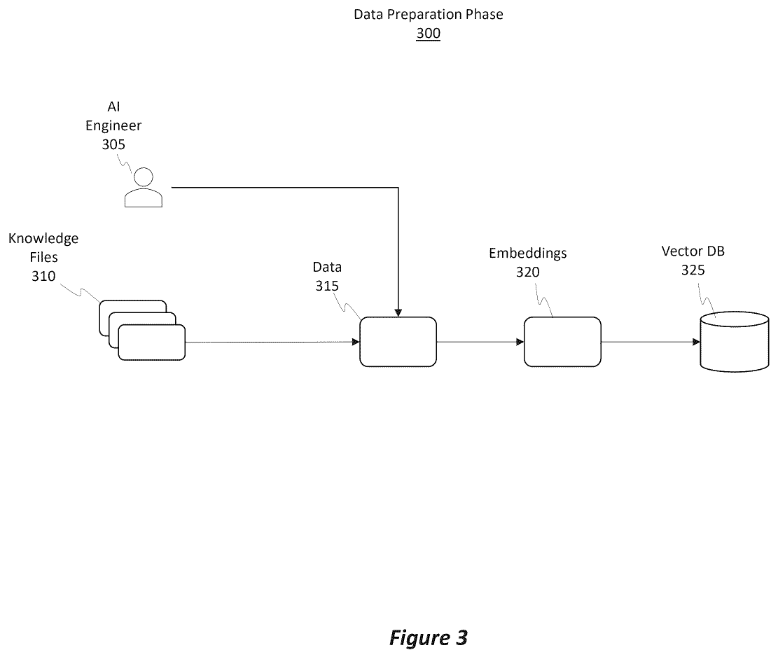

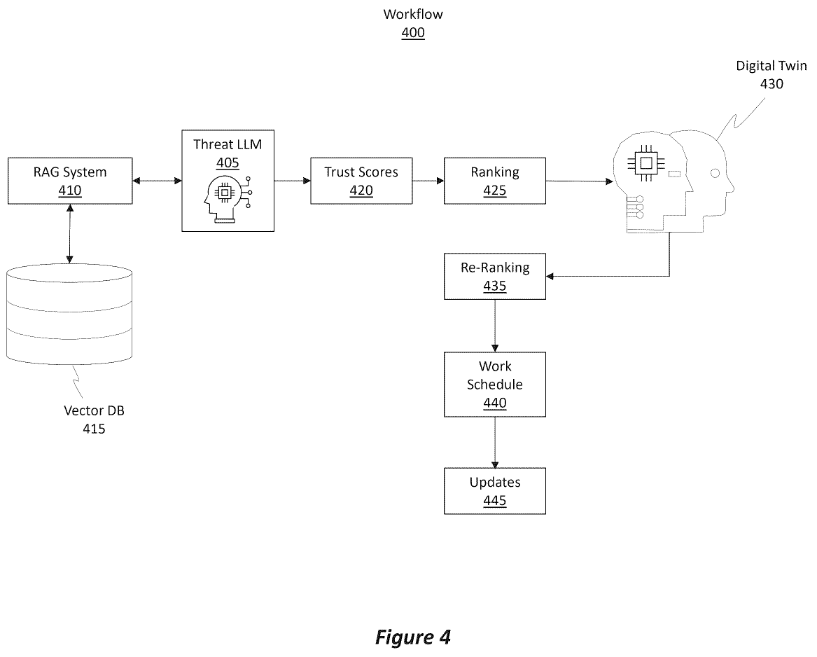

Attention will now be directed to FIGS. 3 and 4, which illustrates operations in which data embeddings are continuously updated based on live threat feeds. The operations described relative to FIGS. 3 and 4 can be orchestrated and/or performed by service 205 of FIG. 2, and the operations in FIGS. 3 and 4 provide additional details regarding the operations just described above. FIG. 3 initially shows a data preparation phase 300.

In FIG. 3, an AI engineer 305 prepares data for preprocessing. Examples of this data include, but certainly are not limited to, any type of knowledge files 310, which may include procedure manuals, product documentation, or help desk tickets. Some of the data may be client data. The client data can be transformed (e.g., from PDF to Text) and/or enriched (e.g., currency) to make that data suitable for model augmentation. The result of preprocessing the data (e.g., the knowledge files 310, client data, etc.) is the data 315.

An embedding model can then be used to convert the source data 315 into a series of vector embeddings 320. The generated vector embeddings 320 are stored in a vector DB 325. The data in the vector DB 325 is now available for use by the RAG system illustrated in FIG. 4, which depicts an example workflow 400.

In FIG. 4, service 205 then retrieves a query, such as perhaps a user query. The query will include one or more different parameters. Service 205 then provides access to the query to the threat LLM 405. The threat LLM 405 includes or has access to the RAG system 410. The RAG system 410 includes or has access to the vector DB 415, which is representative of the vector DB 325 from FIG. 3.

The threat LLM 405 is then tasked with generating a set of one or more solutions or recommendations for the query. Optionally, the solutions can be formatted in human readable text. By “solutions,” it is generally meant that the threat LLM 405 can generate a set of configurations or procedural operations that are performable to cause a source to follow or to be in alignment with a required security policy or a required security posture. A source can be any originator of a security alert. Examples of sources include, but are not limited to, any type of virtual machine, network, node, edge device, and so on. These sources may generate security alerts. Also, these sources may attempt to implement policy. In some scenarios, the sources may not be adequately configured so as to fully comply with the security policy. As such, the threat LLM 405 is able to generate one or more “solutions” that involve operations or configuration changes to enable the source to comply with the security policy. The threat LLM 405 also generates a set of one or more trust scores 420 for the sources. A trust score reflects a source's ability to follow a given security policy/posture. Thus, in FIG. 4, the threat LLM 405 is able to generate and/or assess a source's trust score and update the trust score across tenets.

The threat LLM 405 also creates an initial ranking 425 based on the trust scores 420. This ranking 425 organizes the sources based on their trust scores 420, where the trust scores 420 can be used to reflect the level of criticality or severity a source may have in not following a given policy. For instance, sources that are severely inadequately following a given policy may be ranked near the top of the ranked list, thereby indicating that these sources are ones that should be solved first or as soon as possible. The threat LLM 405 then provides the ranking 425 to a digital twin 430.

Here, the digital twin 430 is a digital representation of the sources and/or network. The digital twin 430 is beneficial because it allows for various simulated solutions to be tested without having to modify the actual source or network architecture. The digital twin 430 is tasked with verifying a given solution's scope, skills requirements, and potentially alternate scenarios for minimum disruption. That is, the digital twin 430 can test the success of a given solution/recommendation.

The digital twin 430 includes the ability to re-rank the list of recommendations based on its own understanding of the trust scores 420, as shown by re-ranking 435. That is, the digital twin 430 updates in real-time as the sources and network updates. The digital twin 430 is thus a real-time representation of current source configurations. It may be the case that the threat LLM 405 is operating on somewhat dated information, whereas the digital twin 430 is operating on real-time data. Thus, it might be the case that the ranking 425 provided by the threat LLM 405 is not strictly optimal due, potentially, to latency. The digital twin 430 can beneficially update the ranked list of solutions.

Service 205 of FIG. 2 can then create various operational work items, as shown by the work schedule 440. Subsequently, service 205 can facilitate various updates 445 to the sources to implement the recommendations, thereby enabling those sources to better follow the policy. Also, the updates 445 occur in accordance with the re-ranked list, resulting in a situation where the most egregious sources are managed first and where less sever sources can be managed later. Accordingly, service 205 is able to update the knowledge files with actual statistics and trust scores and can create remedial policies to prevent future incidences. Service 205 can also notify appropriate personnel, if necessary.

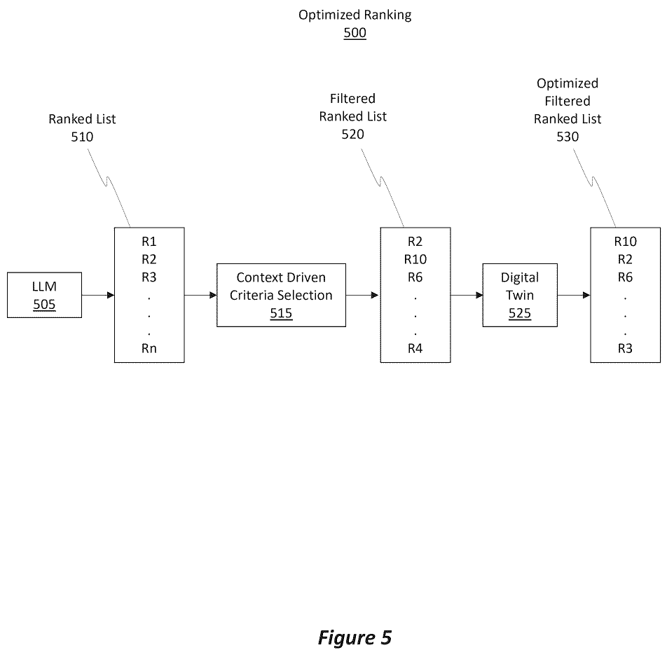

With that understanding, attention will now be directed to FIG. 5, which provides additional details as to how an optimal ranked list of solutions for sources can be generated. Initially, recall how service 205 is able to provide the full set of recommendations at a point in time. The question, though, is that what is deemed the “optimal” solution (e.g., zero trust architecture) at one time may not be the most suitable solution due to changes in the environment and the specific criteria used to generate the recommendations.

At least some of the disclosed embodiments involve a “self-driving threat/incident lifecycle” that encompasses threat identification to resolution. Instead of today's siloed and disjointed approach for collecting data from multiple sources, analyzing for threat identification, analyzing risk to infrastructure in real time and then recommending solution/alerts to address the incidents, some of the embodiments disclosed herein simplify the threat journey by bringing the power of generative AI and security operations.

The disclosed operations beneficially simplify the security journey from reactive to proactive and predictive outcomes, thereby lowering the risk throughout an enterprise's critical infrastructure. The embodiments also beneficially lower the skills requirement for enterprise security, reduce the threat window, and optimize operational time. This ensures that effective security is maintained throughout an enterprise's cyber estate.

Some of the disclosed embodiments implement AI assisted risk analysis using a digital twin to continuously simulate the environment, to analyze the deployed environment, and to assign it a risk score. The digital twin can proactively react to changes in the environment that affect the risk score, and the service 205's recommendation engine can suggest a course of action to mitigate the identified risks.

Some of the embodiments implement automation and orchestration across the entire threat or incident lifecycle at scale using generative AI (GenAI) and RAG techniques to identify latest threats in real-time across a range of siloed events. The embodiments also identify comprehensive risk assessment against simulated environment, threat response solutions, and work prioritizations that match with risk assessment. These operations are driven through the continuous assessment of the trust score of the enterprise's infrastructure. These principles can be used in diverse and heterogenous environments of different scale without changes, thereby allowing it to be used in a single environment as it grows and changes as well as multiple independent environments.

Regarding the self-learning aspect, the embodiments can implement a closed loop solution that detects drift in the digital twin/GenAI solution and can update the recommendation engine, such as by triggering a retraining of the GenAI model (e.g., the threat LLM mentioned herein). Regarding the self-healing aspect, the embodiments can update and deploy policies throughout the threat/incident lifecycle, thereby lowering the risk to critical infrastructure and reducing the time window between mean-time-to-identification to mean-time-to-resolution.

The disclosed techniques optimize the recommendation rankings for security operations dynamically based on changes to the zero trust enabled IT environment, thereby allowing for efficient prioritization of anomalies including at the granular component level. A context driven criteria selection approach enables more accurate and optimized ranking of recommendations. The disclosed approach also provides support for targeted digital twin models at the component level. The improved rankings also enable fine tuning of the service 205's recommendation engine.

FIG. 4 focused on the changing threat landscape of the environment. This solution focused on expected operational changes in a zero trust enabled IT environment over time. FIG. 5, on the other hand, illustrates an optimized ranking 500 set of operations.

FIG. 5 shows the LLM 505, which is representative of the threat LLMs mentioned herein. The LLM 505 (e.g., a “recommendation engine”) generates an initial ranked set of recommendations (e.g., R1 to RN), as shown by ranked list 510. This ranked list 510 is representative of the ranking 425 shown in FIG. 4.

Subsequently, the LLM 505 can filter the recommendations based on dynamically changing criteria (e.g., trust scores, size, scope, criticality) for the environment. This filtering is represented by the context driven criteria selection 515. The result of that filtering in a new filtered ranking of recommendations, as shown by filtered ranked list 520.

The filtered ranked list 520 (as well as any metadata) is then provided to the digital twin 525, which is representative of the digital twin 430 from FIG. 4. The filtered ranked list 520 may not be final and should be validated using the digital twin 525 analysis (e.g., the digital twin 525 is continuously updated based on information about changes in the infrastructure and its environment). It might be the case that the digital twin 525 further modifies the ranked listed, resulting in an optimized filtered ranked list 530 or an optimized re-ranked list of recommendations. Here, the optimized filtered ranked list 530 can then take the place of the re-ranking 435 shown in FIG. 4.

From the list of initial recommendations (e.g., ranked list 510), based on the analysis from the digital twin 525, the re-ranking method can optionally discard various solutions or can reorder the ranking. The output of this process, in addition to the meta data, can then optionally be used for continuous training of the LLM 505, which is used to produce the filtered ranked list 520 of recommendations.

Verification of the proposed operational recommendations normally occur in a pre-preproduction vs. an operational environment to prevent impact to the operational environment. The challenge with this approach is that this test environment lacks the visibility of real-time latency, anomalous or intrusive events, changing policies (e.g., driven by regulation changes) and dynamic changes (e.g., introduction of new components/applications) in the zero trust complex environment.

The disclosed digital twin system provides continuous visibility and traceability of the state of the complex zero trust system down to the granularity of the components within the zero trust system. Thus, the embodiments provide a more accurate environment in which proposed operational recommendations can be verified.

Different combinations of proposed recommendations, including different configurations of related or dependent components of the zero trust system, can be evaluated and analyzed in the digital twin environment. Likewise, the digital twin “rewind” option allows for iterative analysis of the operational recommendations. Therefore, the embodiments can control or influence the implementation of recommendations in a precise order of sequence.

The live monitoring of the complex zero trust system allows the digital twin to detect drift in the physical environment and can facilitate adjustment to the proposed recommendations considering the current state and the specified policies of the complex zero trust system.

In this manner, the digital twin provides a representative but separate environment where proposed operational recommendations can be verified without impacting the operational environment. The digital twin's “rewind” option allows for iterative analysis of the operational recommendations and the specification of the precise order in which recommendations should be implemented. The digital twin can drive anomalous event detection, root cause analysis, and impact assessment enriches operational recommendations and expedites implementation of remediation.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

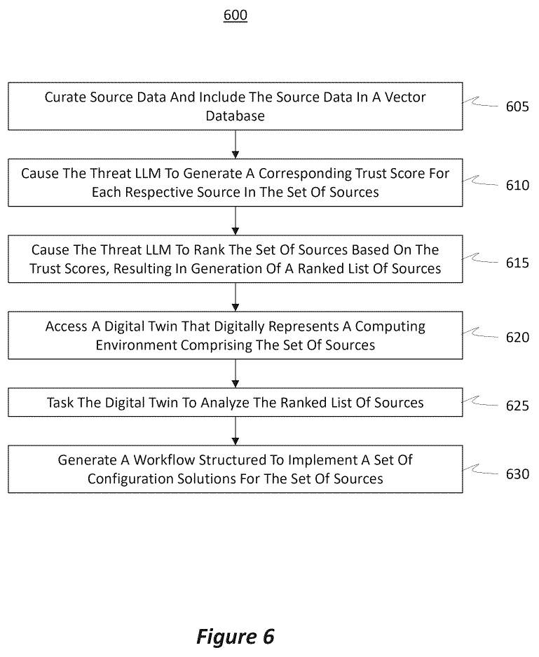

Attention will now be directed to FIG. 6, which illustrates a flowchart of an example method 600 for generating optimized rankings of operational recommendations/solutions based on trust scores, size, scope, and criticality. Such operations can be performed via the use of a digital twin, which can simulate operational recommendations to verify a given solution's scope, skills requirements, and provide an alternative scenario for minimum disruption. Method 600 can be implemented within the architecture 200 of FIG. 2 and can be orchestrated by service 205.

Method 600 includes an act (act 605) of curating source data and including the source data in a vector database. The vector database is accessible to a threat large language model (LLM). The source data is associated with a set of sources that are being evaluated to determine security postures for the set of sources based on the set of sources adherence to a set of one or more security policies. Optionally, the source data is converted to vector embeddings data prior to inclusion in the vector database.

As one option, the source data includes enterprise data (e.g., procedure data, manual data, etc.) associated with the computing environment. As another option, the source data includes client data associated with the set of sources. In one scenario, the set of sources includes a virtual machine, a network, or any other type of computing node.

Act 610 includes causing the threat LLM to generate a corresponding trust score for each respective source in the set of sources. Notably, the trust scores reflect the security postures for the set of sources.

Act 615 includes causing the threat LLM to rank the set of sources based on the trust scores. This ranking operation results in the generation of a ranked list of sources.

Ranking the set of sources based on the trust scores includes placing sources having relatively worse trust scores higher in the ranked list of sources. This ranking further includes placing sources having relatively better trust scores lower in the ranked list of sources. In one scenario, sources placed higher in the ranked list of sources are sources that are prioritized for reconfiguration to enable those sources to adhere to the security policies.

Act 620 includes accessing a digital twin that digitally represents a computing environment comprising the set of sources.

Act 625 includes tasking the digital twin to analyze the ranked list of sources. The digital twin is further tasked with re-ranking the ranked list of sources based on real-time status data for the computing environment. The digital twin generates a re-ranked list of sources.

In one scenario, prior to tasking the digital twin to analyze the ranked list of sources, the ranked list of sources is subjected to a filtering operation based on acquired context associated with the computing environment. This filtering operation results in a modification to the ranked list of sources, as was shown in FIG. 5.

Act 630 includes generating a workflow structured to implement a set of configuration solutions for the set of sources. Notably, the set of configuration solutions are structured to cause the set of sources to at least attempt to adhere to the security policies. Also, an order of the workflow is based on the re-ranked list of sources.

As one option, the digital twin includes a rewind feature. This rewind feature enables the digital twin to undo configuration changes. Also, the digital twin updates in response to updates made to the computing environment.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, classifiers, and component are examples of terms that may refer to software objects or routines that execute on the computing system. The different components, modules, engines, services, and classifiers described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

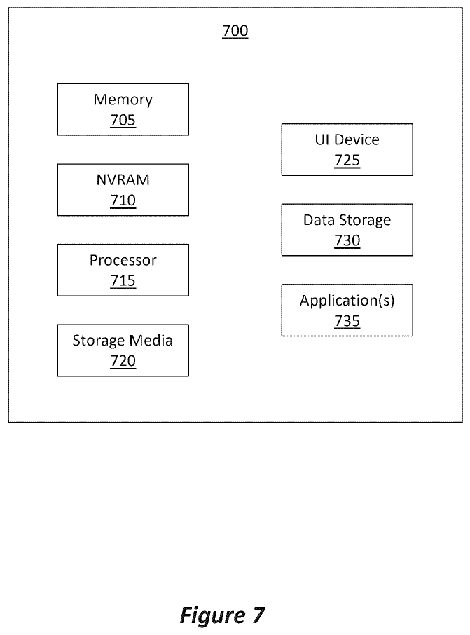

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. This example device can be implemented in architecture 200 of FIG. 2 and can host service 205. Also, where any of the aforementioned elements comprise or consist of a virtual machine (VM), that VM may constitute a virtualization of any combination of the physical components disclosed in FIG. 7.

In the example of FIG. 7, the physical computing device 700 includes a memory 705 which may include one, some, or all, of random access memory (RAM), non-volatile memory (NVM) 710 such as NVRAM for example, read-only memory (ROM), and persistent memory, one or more hardware processors 715, non-transitory storage media 720, UI device 725, and data storage 730. One or more of memory 705 of the physical computing device 700 may take the form of solid-state device (SSD) storage. Also, one or more applications 735 may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 700 may also be representative of an edge system, a cloud-based system, a datacenter or portion thereof, or other system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
curating source data and including the source data in a vector database, wherein the vector database is accessible to a threat large language model (LLM), and wherein the source data is associated with a set of sources that are being evaluated to determine security postures for the set of sources based on the set of sources adherence to a set of one or more security policies;
causing the threat LLM to generate a corresponding trust score for each respective source in the set of sources, wherein the trust scores reflect the security postures for the set of sources;
causing the threat LLM to rank the set of sources based on the trust scores, resulting in generation of a ranked list of sources;
accessing a digital twin that digitally represents a computing environment comprising the set of sources;
tasking the digital twin to analyze the ranked list of sources, wherein the digital twin is further tasked with re-ranking the ranked list of sources based on real-time status data for the computing environment, and wherein the digital twin generates a re-ranked list of sources; and
generating a workflow structured to implement a set of configuration solutions for the set of sources, wherein the set of configuration solutions are structured to cause the set of sources to at least attempt to adhere to the security policies, and wherein an order of the workflow is based on the re-ranked list of sources.

2. The method of claim 1, wherein the source data includes enterprise data associated with the computing environment.

3. The method of claim 1, wherein the source data includes client data associated with the set of sources.

4. The method of claim 1, wherein ranking the set of sources based on the trust scores includes placing sources having relatively worse trust scores higher in the ranked list of sources and placing sources having relatively better trust scores lower in the ranked list of sources.

5. The method of claim 4, wherein sources placed higher in the ranked list of sources are sources that are prioritized for reconfiguration to enable said sources to adhere to the security policies.

6. The method of claim 1, wherein, prior to tasking the digital twin to analyze the ranked list of sources, the ranked list of sources is subjected to a filtering operation based on acquired context associated with the computing environment, and wherein said filtering operation results in a modification to the ranked list of sources.

7. The method of claim 1, wherein the digital twin includes a rewind feature that enables the digital twin to undo configuration changes.

8. The method of claim 1, wherein the digital twin updates in response to updates made to the computing environment.

9. The method of claim 1, wherein the set of sources includes a virtual machine.

10. The method of claim 1, wherein the source data is converted to vector embeddings data prior to inclusion in the vector database.

11. A method comprising:
accessing source data included in a vector database, wherein the vector database is accessible to a threat large language model (LLM), and wherein the source data is associated with a set of sources that are being evaluated to determine security postures for the set of sources based on the set of sources adherence to a set of one or more security policies;
causing the threat LLM to generate a corresponding trust score for each respective source in the set of sources, wherein the trust scores reflect the security postures for the set of sources;
causing the threat LLM to rank the set of sources based on the trust scores, resulting in generation of a ranked list of sources;
accessing a digital twin that digitally represents a computing environment comprising the set of sources;
tasking the digital twin to analyze the ranked list of sources, wherein the digital twin is further tasked with re-ranking the ranked list of sources based on real-time status data for the computing environment, and wherein the digital twin generates a re-ranked list of sources; and
generating a workflow structured to implement a set of configuration solutions for the set of sources, wherein the set of configuration solutions are structured to cause the set of sources to at least attempt to adhere to the security policies, and wherein an order of the workflow is based on the re-ranked list of sources.

12. The method of claim 11, wherein the source data includes enterprise data associated with the computing environment.

13. The method of claim 11, wherein the source data includes client data associated with the set of sources.

14. The method of claim 11, wherein ranking the set of sources based on the trust scores includes placing sources having relatively worse trust scores higher in the ranked list of sources and placing sources having relatively better trust scores lower in the ranked list of sources.

15. The method of claim 14, wherein sources placed higher in the ranked list of sources are sources that are prioritized for reconfiguration to enable said sources to adhere to the security policies.

16. The method of claim 11, wherein, prior to tasking the digital twin to analyze the ranked list of sources, the ranked list of sources is subjected to a filtering operation based on acquired context associated with the computing environment, and wherein said filtering operation results in a modification to the ranked list of sources.

17. The method of claim 11, wherein the digital twin includes a rewind feature that enables the digital twin to undo configuration changes.

18. A computer system comprising:
one or more processors; and
one or more hardware storage devices that store instructions that are executable by the one or more processors to cause the computer system to:
access source data included in a vector database, wherein the vector database is accessible to a threat large language model (LLM), and wherein the source data is associated with a set of sources that are being evaluated to determine security postures for the set of sources based on the set of sources adherence to a set of one or more security policies;
cause the threat LLM to generate a corresponding trust score for each respective source in the set of sources, wherein the trust scores reflect the security postures for the set of sources;
cause the threat LLM to rank the set of sources based on the trust scores, resulting in generation of a ranked list of sources;
access a digital twin that digitally represents a computing environment comprising the set of sources;
task the digital twin to analyze the ranked list of sources, wherein the digital twin is further tasked with re-ranking the ranked list of sources based on real-time status data for the computing environment, and wherein the digital twin generates a re-ranked list of sources; and
generate a workflow structured to implement a set of configuration solutions for the set of sources, wherein the set of configuration solutions are structured to cause the set of sources to at least attempt to adhere to the security policies, and wherein an order of the workflow is based on the re-ranked list of sources.

19. The computer system of claim 18, wherein the source data includes enterprise data associated with the computing environment and further includes client data associated with the set of sources.

20. The computer system of claim 18, wherein, prior to tasking the digital twin to analyze the ranked list of sources, the ranked list of sources is subjected to a filtering operation based on acquired context associated with the computing environment, and wherein said filtering operation results in a modification to the ranked list of sources.
